(19) United States
(12) Patent Application Publication
(10) Pub. No.: US 2001/0012171 A1
(43) Pub. Date: Aug. 9, 2001

(54) Power-off method and device for electronic storage apparatus

(75) Inventors: Li-Hsin Lu, San Jose, CA (US); Stephen R. Jackson, San Jose, CA (US); David Drouin, Milpitas, CA (US)

Correspondence Address: TOWNSEND AND TOWNSEND AND CREW, TWO EMBARCADERO CENTER, EIGHTH FLOOR, SAN FRANCISCO, CA, 94111-3834, US

(73) Assignee: Castlewood Systems, Inc.

(21) Appl. No.: 09/728,738

(22) Filed: Nov. 30, 2000

Related U.S. Application Data
(63) Continuation of application No. 09/075,860, filed on May 11, 1998, now abandoned.
(60) Provisional application No. 60/065,998, filed on Nov. 14, 1997.

(51) Int. Cl. G11B 5/596

(52) U.S. Cl. 360/78.04; 360/75

(57) ABSTRACT

A method for positioning a magneto-resistive head onto an head load/unload ramp of a storage unit, the magneto-resistive head disposed upon an actuator arm, the actuator arm also having a voice coil, includes the steps of detecting a reset signal, generating a back electro-motive force voltage with a spindle motor in response to the reset signal, generating a drive voltage in response to the back electro-motive force voltage, using a switching circuit to provide the drive voltage to the voice coil in a first polarity for a first period of time, and thereafter, using the switching circuit to provide the drive voltage to the voice coil in a second polarity.

### BACKGROUND OF THE INVENTION

The present invention generally relates to removable storage devices for electronic information. More particular, the present invention provides a technique including an apparatus and methods for the movement and operation of a storage device including a magnetic head used to read and write data into a removable disk.

Consumer electronics including television sets, personal computers, and stereo or audio systems, have changed dramatically since their availability. Television was originally used as a stand alone unit in the early 1900's, but has now been integrated with audio equipment to provide video with high quality sound in stereo. For instance, a television set can have a high quality display coupled to an audio system with stereo or even “surround sound” or the like. This integration of television and audio equipment provides a user with a high quality video display for an action movie such as STARWARS™ with “life-like” sound from the high quality stereo or surround sound system. Accordingly, the clash between Luke Skywalker and Darth Vader can now be seen as well as heard in surround sound on your own home entertainment center. In the mid-1990's, computer-like functions became available on a conventional television set. Companies such as WebTV of California provide what is commonly termed as “Internet” access to a television set. The Internet is a world wide network of computers, which can now be accessed through a conventional television set at a user location. Numerous displays or “wet sites” exist on the Internet for viewing and even ordering goods and services at the convenience of home, where the act of indexing through websites is known as “surfing” the web. Accordingly, users of WebTV can surf the Internet or web using a home entertainment center.

As merely an example, FIG. 1 illustrates a conventional audio and video configuration, commonly termed a home entertainment system, which can have Internet access. FIG. 1 is generally a typical home entertainment system, which includes a video display 10 (e.g., television set), an audio output 20, an audio processor 30, a video display processor 40, and a plurality of audio or video data sources 50. Consumers have often been eager to store and play back pre-recorded audio (e.g., songs, music) or video using a home entertainment system. Most recently, consumers would like to also store and retrieve information, commonly termed computer data, downloaded from the Internet.

Music or audio have been traditionally recorded on many types of systems using different types of media to provide audio signals to home entertainment systems. For example, these audio systems include a reel to reel system 140, using magnetic recording tape, an eight track player 120, which uses eight track tapes, a phonograph 130, which uses LP vinyl records, and an audio cassette recorder 110, which relies upon audio cassettes. Optical storage media also have been recognized as providing convenient and high quality audio play-back of music, for example. Optical storage media exclusively for sound include a digital audio tape 90 and a compact disk 10. Unfortunately, these audio systems generally do not have enough memory or capacity to store both video and audio to store movies or the like. Tapes also have not generally been used to efficiently store and retrieve information from a personal computer since tapes are extremely slow and cumbersome.

Audio and video have been recorded together for movies using a video tape or video cassette recorder, which relies upon tapes stored on cassettes. Video cassettes can be found at the local Blockbuster™ store, which often have numerous different movies to be viewed and enjoyed by the user. Unfortunately, these tapes are often too slow and clumsy to store and easily retrieve computer information from a personal computer. Additional video and audio media include a laser disk 70 and a digital video disk 60, which also suffer from being read only, and cannot be easily used to record a video at the user site. Furthermore, standards for a digital video disk have not been established of the filing date of this patent application and do not seem to be readily establishable in the future.

From the above, it is desirable to have a storage media that can be used for all types of information such as audio, video, and digital data, which have features such as a high storage capacity, expandability, and quick access capabilities.

With typical disk-based storage devices, upon turning-off, emergency power-off, etc. of such storage devices, the read/write heads typically are moved to a safe position not on top of the data storing region of the disk. Typical positions include a crash landing region, often located at the inner or outer diameter of the disk, a head load/unload ramp, often located outside the outer diameter of the disk, and the like.

When powering-off of disk-based storage devices, such storage devices often rely upon a generated Back Electro-Motive Force (back EMF, VBEMF, VEMF) to cause the movement of the heads to the safe position. This back EMF is typically produced by a spindle motor of the disk drive when the power is removed. The back EMF is typically supplied to the read/write head mechanism (typically via a voice coil motor (VCM) attached to an actuator upon which the read/write heads are positioned) to cause movement of the read/write heads to the safe position.

Drawbacks to relying upon such back EMF methods include that the read/write heads are not always reliably unloaded. This occurs because the amount of energy applied to the read/write heads is related to the position of the read/write heads on the magnetic disk before power-off. For example, if the read/write heads are positioned near the outer diameter of the magnetic disk, upon power-off, the read/write heads are towards the outer diameter of the magnetic disk and towards a load/unload ramp (loading ramp). However, since the read/write heads are near the outer diameter already, very little back EMF energy (work energy) is applied before the read/write heads are unloaded onto the loading ramp, if at all. In a case where the read/write heads are positioned near the middle diameter of the magnetic disk, upon power-off, more back EMF (work energy) is imparted to the read/write mechanism than the example above. Because of this, the read/write heads are typically unloaded further up the head load/unload ramp. Current systems ignore such differences in read/write head positions for power-off purposes.

These drawbacks also apply if the read/write heads are to be positioned at a region on the inner diameter of the disk. If the read/write heads are not reliable moved to a safe position in either case, the read/write heads may bounce around the storage device, damage the data portions of the magnetic disk, damage the read/write heads cause mis-alignments in the read/write heads, and other damage.

Another drawback is that the amount of back EMF energy provided is insufficient in some situations to reliably unload the read/write heads up onto the head load/unload ramp.

FIG. 8 illustrates one circuit used to park a read/write head in an inner crash stop. This circuit includes an op-amp, with a back EMF (VBEMF) supplying the power to the op amp. The output of the op amp (Vcoil) is applied to the VCM of the actuator.

In response to a power-on-reset (POR) signal, a current source I is coupled directly to one input of the op-amp, is coupled via a resistor R to the other input of the op amp. As a result, the output of this circuit, Vcoil is equal to I*R. Because VEMF is not constant, Vcoil is actually limited by the voltage of VEMF, further, ______

<what are the drawback of this design? This is prior art right?>

Thus what is required are methods and apparatus for providing more reliable unloading of read/write heads in order to protect the read/write heads as well as the disk media.

### SUMMARY OF THE INVENTION

According to the present invention, a technique including methods and a device for providing a single type of media for electronic storage applications is provided. In an exemplary embodiment, the present invention provides a methods and apparatus for unloading of MR heads from the surface of removable media.

According to an embodiment of the present invention, a method for positioning a magneto-resistive head of actuator arm, also having a voice coil, onto a head load/unload ramp of a storage unit, the method includes the steps of detecting a reset signal, generating a back electro-motive force voltage with a spindle motor in response to the reset signal, and generating a drive voltage in response to the back electro-motive force voltage. The method also includes the steps of using a switching circuit to provide the drive voltage to the voice coil in a first polarity for a first period of time, and thereafter, using the switching circuit to provide the drive voltage to the voice coil in a second polarity.

According to an embodiment, a system including a storage unit includes an actuator arm with a magneto resistive read/write head and voice coil, is for repositioning a magneto resistive head from a position adjacent to a surface of a magnetic disk onto a head load/unload ramp. The storage unit includes a reset generator for asserting a reset signal, a spindle motor coupled to the magnetic disk and to the reset generator for rotating the magnetic disk, and for generating an EMF voltage in response to the reset signal and a switching circuit coupled to a first terminal of the voice coil, to a second terminal of the voice coil, and to the reset generator, the switching circuit for providing a drive voltage to the first terminal of the voice coil and for coupling ground to the second terminal of the voice coil, in response to the reset signal. The storage unit also includes a voice coil driver coupled to the reset generator, the spindle motor, and to the switching circuit, the voice coil driver for generating the drive voltage in response to the EMF voltage.

The voice coil driver includes a charge pump for providing a charge pump voltage, a first resistor having a first terminal coupled in series to the switching circuit for providing the drive voltage, a second resistor having a first terminal coupled to receive the charge pump voltage, a first NMOS transistor having a source, a drain, and a gate, the source coupled to a second terminal of the first resistor, the drain coupled to receive the EMF voltage, the first NMOS transistor for providing the EMF voltage to the first resistor when saturated, and a PMOS transistor having a source, a drain, and a gate, the source coupled to receive the charge pump voltage, the gate coupled to a second terminal of the second resistor, and the source coupled to the gate of the first NMOS transistor for providing the charge pump voltage to the gate of the first NMOS transistor and for causing the first NMOS transistor to saturate when the PMOS transistor is saturated.

The voice coil driver also includes a third resistor having a first terminal that is grounded, a second NMOS transistor having a source, a drain, and a gate, the drain coupled to ground, the source coupled to the second terminal of the third resistor, and the source coupled to the gate of the PMOS transistor for causing the PMOS transistor to saturate when the second NMOS transistor is saturated, and a switch coupled to the EMF voltage and to the gate of the second NMOS transistor for coupling the EMF voltage to the gate of the second NMOS transistor and for causing the second NMOS transistor to saturate in response to the reset signal.

Numerous benefits are achieved by way of the present invention. For instance, the present invention provides an efficient technique for using kinetic energy from a rotating disk of a storage device and other sources of energy during a power down step to perform housekeeping functions in the storage device. The present invention provides these functions without the use of complex drive motors or the like, which are often used in conventional techniques. The present invention further provides a more reliable method for providing such functions. Depending upon the embodiment, the present invention provides at least one of these if not all of these benefits and others, which are further described throughout the present specification.

Further understanding of the nature and advantages of the invention may be realized by reference to the remaining portions of the specification and drawings.

### BRIEF DESCRIPTION OF THE DRAWINGS

FIG. 1 illustrates a conventional audio and video configuration;

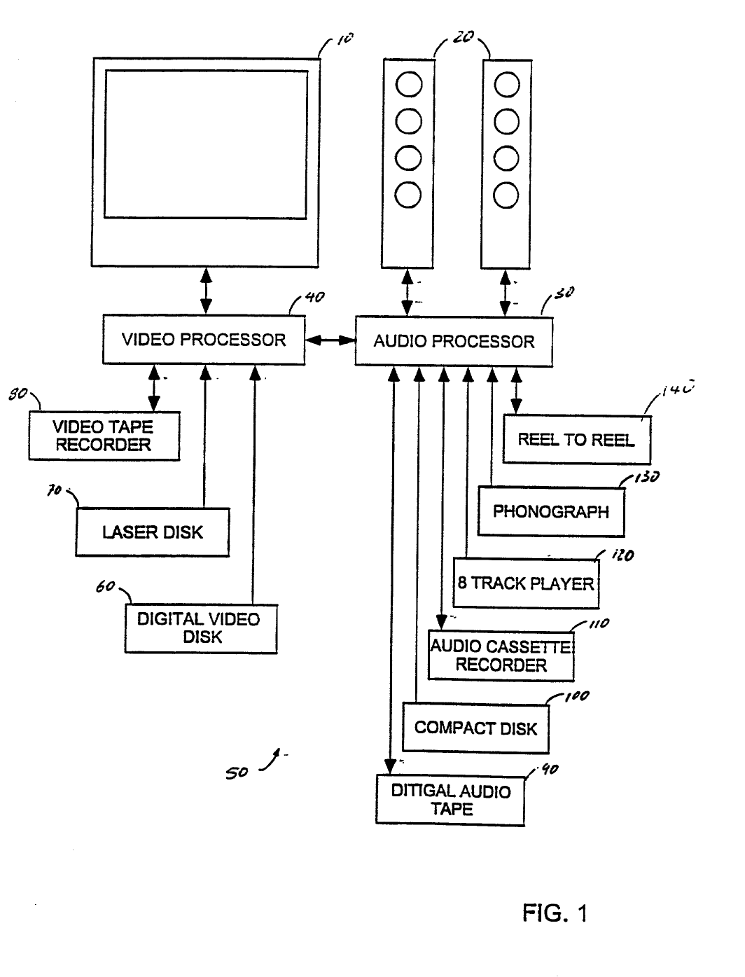

FIG. 2 illustrates a system according to an embodiment of the present invention;

FIG. 3 includes a detailed block diagram of a system 200 according to an embodiment of the present invention;

FIGS. 4A and 4B illustrate a storage unit according to an embodiment of the present invention;

FIGS. 5A-5F illustrate simplified views and a storage unit for reading and/or writing from a removable media cartridge;

FIG. 6 illustrates a functional block diagram of an embodiment of the present invention;

FIG. 7 illustrates a functional block diagram of a circuit for unloading read/write heads from the magnetic disk and onto a loading/unloading ramp;

FIG. 8 illustrates one circuit used to park a read/write head in an inner crash stop;

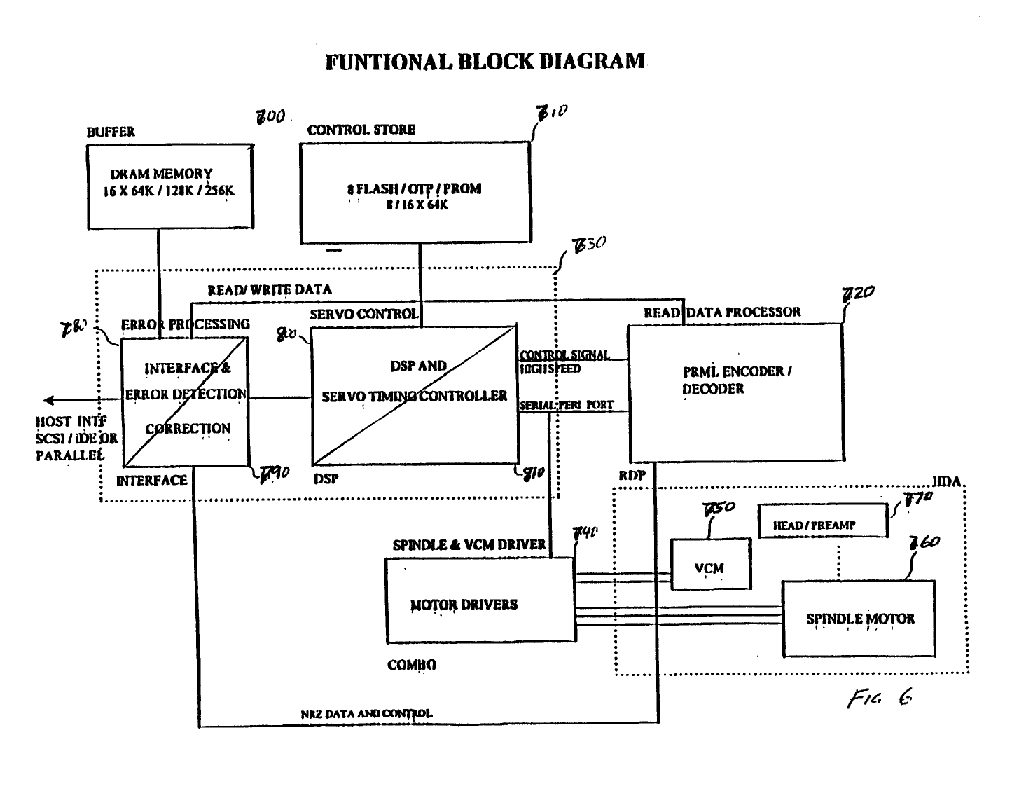

FIG. 9 illustrates a solenoid driving circuit according to an embodiment of the present invention;

FIG. 10 illustrates another solenoid driving circuit according to an embodiment of the present invention; and

FIG. 11 illustrates a block diagram of a method for unloading heads according to an embodiment of the present invention.

### DESCRIPTION OF SPECIFIC EMBODIMENTS

System Overview

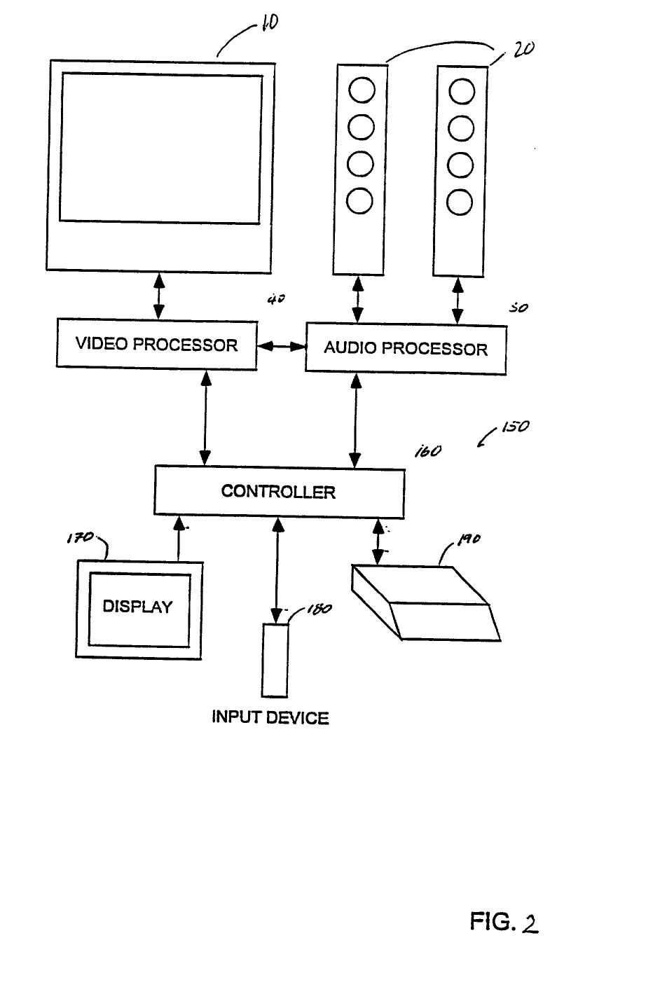

FIG. 2 is a simplified block diagram of a system according to an embodiment of the present invention. This embodiment is merely an illustration and should not limit the scope of the claims herein. The system 150 includes the television display 10, which is capable of Internet access or the like, the audio output 20, a controller 160, a user input device 180, a novel storage unit 190 for storing and accessing data, and optionally a computer display 170. Output from system 150 is often audio and/or video data and/or data that is generally input into audio processor 30 and/or video processor 40.

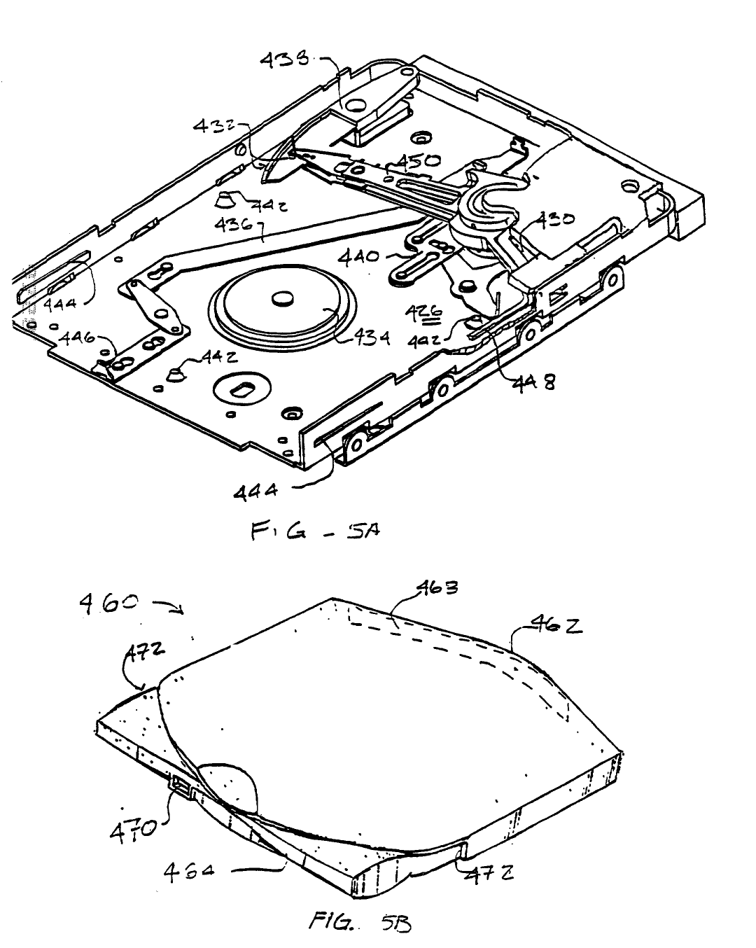

The storage unit includes a high capacity removable media cartridge, such as the one shown in FIGS. 5B & 5C, for example. The removable media cartridge can be used to record and playback information from a video, audio, or computer source. The cartridge is capable of storing at least 2 GB of data or information. The cartridge also has an efficient or fast access time of about 13 ms and less, which is quite useful in storing data for a computer. The cartridge is removable and storable. For example, the cartridge can store up to about 18 songs, which average about 4 minutes in length. Additionally, the cartridge can store at least 0.5 for MPEGII-2 for MPEGI full length movies, which each runs about 2 hours. Furthermore, the cartridge can be easily removed and stored to archive numerous songs, movies, or data from the Internet or the like. Accordingly, the high capacity removable media provides a single unit to store information from the video, audio, or computer. Further details of the storage unit are provided below.

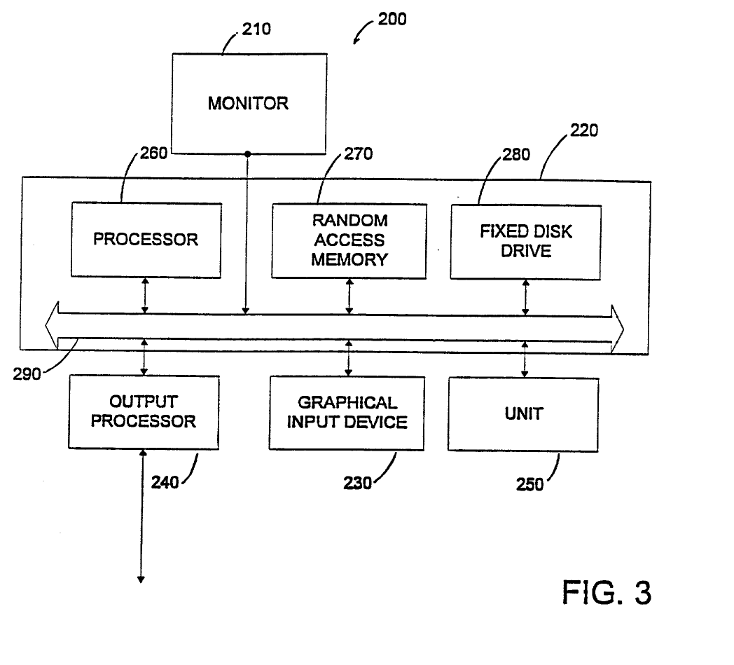

In an alternative embodiment, FIG. 3 is a simplified block diagram of an audio/video/computer system 200. This diagram is merely an illustration and should not limit the scope of the claims herein. The system 200 includes a monitor 210, a controller 220, a user input device 230, an output processor 240, and a novel electronic storage unit 250 preferably for reading and writing from a removable media source, such as a cartridge. Controller 220 preferably includes familiar controller components such as a processor 260, and memory storage devices, such as a random access memory (RAM) 270, a fixed disk drive 280, and a system bus 290 interconnecting the above components.

User input device 230 may include a mouse, a keyboard, a joystick, a digitizing tablet, a wireless controller, or other graphical input devices, and the like. RAM 270 and fixed disk drive 280 are mere examples of tangible media for storage of computer programs and audio and/or video data, other types of tangible media include floppy disks, optical storage media such as CD-ROMs and bar codes, semiconductor memories such as flash memories, read-only-memories (ROMs), ASICs, battery-backed volatile memories, and the like. In a preferred embodiment, controller 220 includes a '586 class microprocessor running Windows95™ operating system from Microsoft Corporation of Redmond, Wash. Of course, other operating systems can also be used depending upon the application.

The systems above are merely examples of configurations, which can be used to embody the present invention. It will be readily apparent to one of ordinary skill in the art that many system types, configurations, and combinations of the above devices are suitable for use in light of the present disclosure. For example, in alternative embodiments of FIG. 2, for example, video display 10 is coupled to controller 220 thus a separate monitor 210 is not required. Further, user input device 230 also utilizes video display 10 for graphical feedback and selection of options. In yet other embodiments controller 220 is integrated directly into either audio processor 20 or video processor 30, thus separate output processor 240 is not needed. In another embodiment, controller 220 is integrated directly into video display 10. Of course, the types of system elements used depend highly upon the application.

Detailed Description

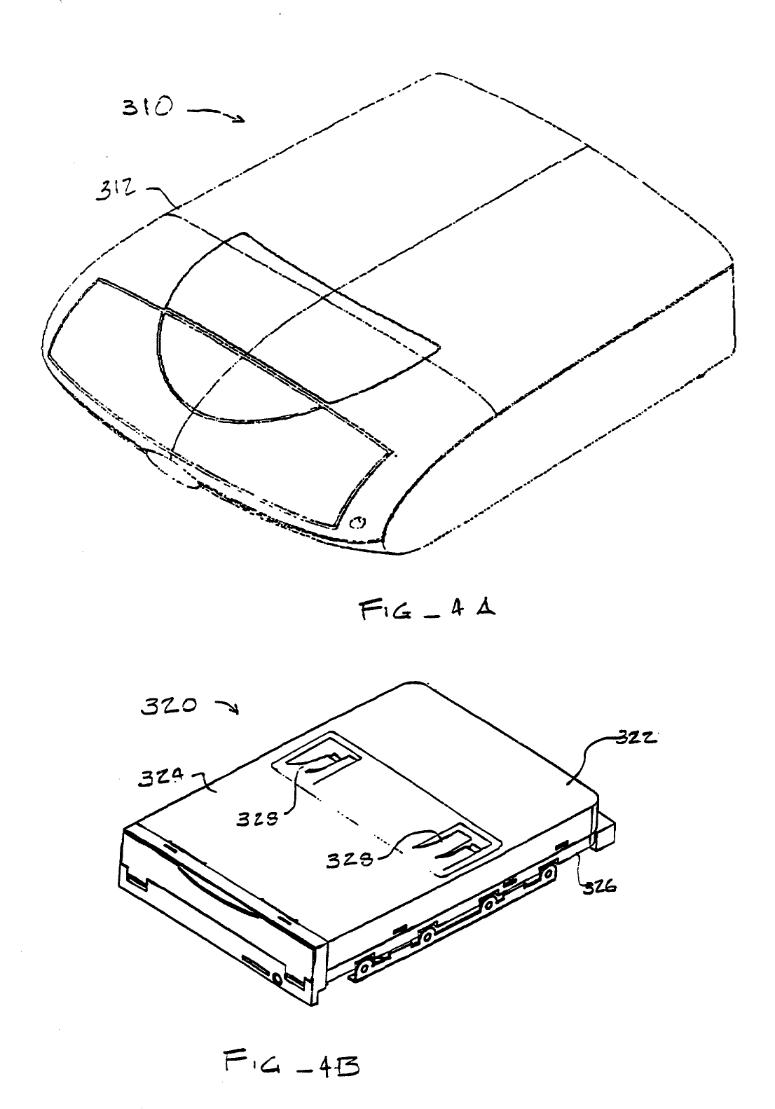

Referring now to FIGS. 4A and 4B, a storage unit according to the present embodiment can be an external disk drive 310 or internal disk drive 320 unit, which shares many of the same components. However, external drive 310 will include an enclosure 312 adapted for use outside a personal computer, television, or some other data manipulation or display device. Additionally, external drive 310 will include standard I/O connectors, parallel ports, and/or power plugs similar to those of known computer peripheral or video devices.

Internal drive 320 will typically be adapted for insertion into a standard bay of a computer. In some embodiments, internal drive 310 may instead be used within a bay in a television set such as HDTV, thereby providing an integral video system. Internal drive 320 may optionally be adapted for use with a bay having a form factor of 3 inches, 2.5 inches, 1.8 inches, 1 inch, or with any other generally recognized or proprietary bay. Regardless, internal drive 320 will typically have a housing 322 which includes a housing cover 324 and a base plate 326. As illustrated in FIG. 4B, housing 324 will typically include integral springs 328 to bias the cartridge downward within the receiver of housing 322. It should be understood that while external drive 310 may be very different in appearance than internal drive 320, the external drive will preferably make use of base plate 326, cover 324, and most or all mechanical, electromechanical, and electronic components of internal drive 320.

Many of the components of internal drive 320 are visible when cover 322 has been removed, as illustrated in FIG. 5A. In this exemplary embodiment, an actuator 450 having a voice coil motor 430 positions first and second heads 432 along opposed recording surfaces of the hard disk while the disk is spun by spindle drive motor 434. A release linkage 436 is mechanically coupled to voice coil motor 430, so that the voice coil motor effects release of the cartridge from housing 422 when heads 432 move to a release position on a head load ramp 438. Head load ramp 438 is preferably adjustable in height above base plate 426, to facilitate aligning the head load ramp with the rotating disk.

A head retract linkage 440 helps to ensure that heads 432 are retracted from the receptacle and onto head load ramp 438 when the cartridge is removed from housing 422. Head retract linkage 440 may also be used as an inner crash stop to mechanically limit travel of heads 432 toward the hub of the disk.

Base 426 preferably comprise a stainless steel sheet metal structure in which the shape of the base is primarily defined by stamping, the shape ideally being substantially fully defined by the stamping process. Bosses 442 are stamped into base 426 to engage and accurately position lower surfaces of the cartridge housing. To help ensure accurate centering of the cartridge onto spindle drive 434, rails 444 maintain the cartridge above the associated drive spindle until the cartridge is substantially aligned axially above the spindle drive, whereupon the cartridge descends under the influence of cover springs 428 and the downward force imparted by the user. This brings the hub of the disk down substantially normal to the disk into engagement with spindle drive 434. A latch 446 of release linkage 436 engages a detent of the cartridge to restrain the cartridge, and to maintain the orientation of the cartridge within housing 422.

A cartridge for use with internal drive 320 is illustrated in FIGS. 5B and 5C. Generally, cartridge 460 includes a front edge 462 and rear edge 464. A disk 666 (see FIG. 5F) is disposed within cartridge 460, and access to the disk is provided through a door 568. A detent 470 along rear edge 464 of cartridge 460 mates with latch 446 to restrain the cartridge within the receptacle of the drive, while rear side indentations 472 are sized to accommodate side rails 444 to allow cartridge 460 to drop vertically into the receptacle.

Side edges 574 of cartridge 460 are fittingly received between side walls 576 of base 526, as illustrated in FIG. 5D. This generally helps maintain the lateral position of cartridge 460 within base 426 throughout the insertion process. Stops 578 in sidewall 576 stop forward motion of the cartridge once the hub of disk 666 is aligned with spindle drive 534, at which point rails 444 are also aligned with rear indents 472. Hence, the cartridge drops roughly vertically from that position, which helps accurately mate the hub of the disk with the spindle drive.

FIG. 5F also illustrates a typical first position 667 of VCM 668 and a typical second position 669 in response to different magnetic fluxes from a motor driver. As a result, read/write heads 632 are repositioned relative to disk 666 as shown.

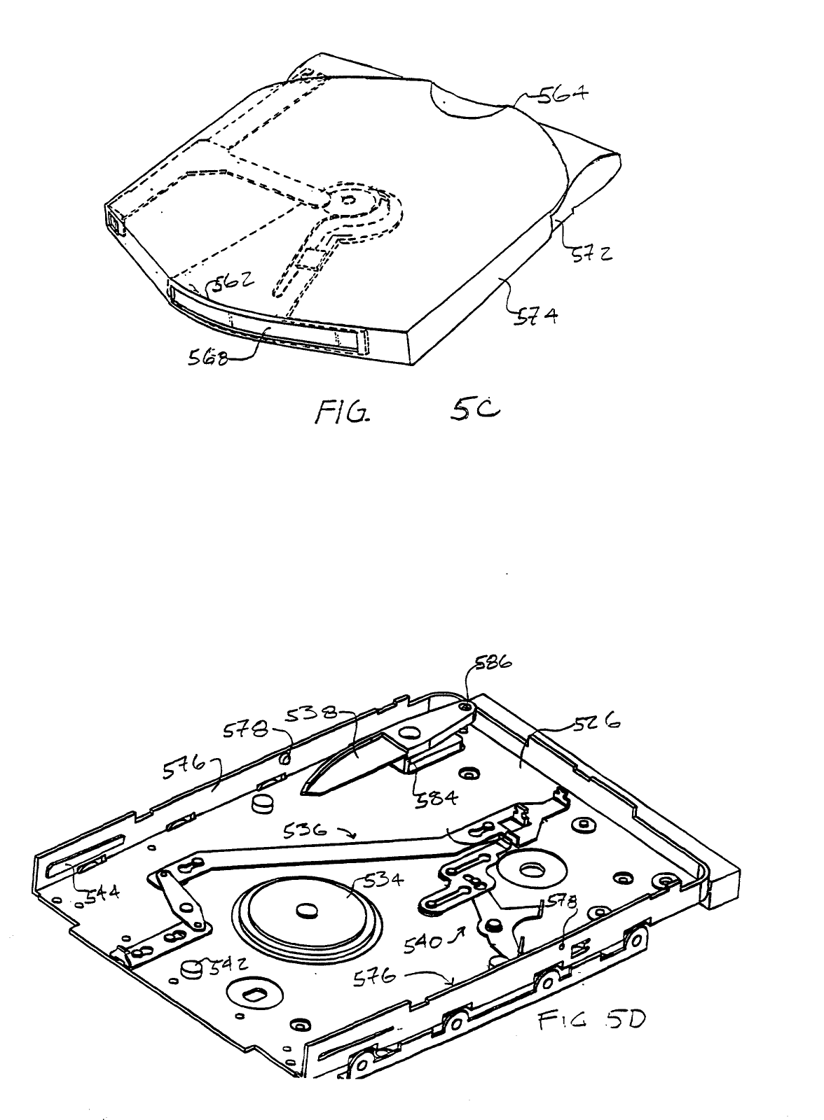

FIG. 6 illustrates a simplified functional block diagram of an embodiment of the present invention. FIG. 6 includes a buffer 700, a control store 710, a read data processor 720, a controller 730, motor drivers 740, a voice coil motor 750, a spindle motor 760, and read/write heads 770. Controller 730 includes interface module 780, an error detection and correction module 790, a digital signal processor 800, and a servo timing controller 810. Voice coil motor 750 preferably corresponds to voice coil motor 430 in FIG. 5A, spindle motor 760 preferably corresponds to spindle drive motor 434 in FIG. 5A, and read/write heads 770 preferably correspond to read/write heads 432 on actuator arm 450 in FIG. 5A.

As illustrated in FIG. 6, buffer 700 typically comprises a conventional DRAM, having 16 bits×64K, 128K, or 256K, although other sized buffers are also envisioned. Buffer 700 is typically coupled to error detection and correction module 790. Buffer 700 preferably serves as a storage of data related to a specific removable media cartridge. For example, buffer 700 preferably stores data retrieved from a specific removable media cartridge (typically a magnetic disk), such as media composition and storage characteristics, the location of corrupted locations, the data sector eccentricity of the media, the non-uniformity of the media, the read and write head offset angles for different data sectors of the media and the like. Buffer 700 also preferably stores data necessary to compensate for the specific characteristics of each removable media cartridge, as described above. Buffer 700 typically is embodied as a 1 Meg DRAM from Sanyo, although other vendors' DRAMs may also be used. Other memory types such as SRAM and flash RAM are contemplated in alternative embodiments. Further, other sizes of memory are also contemplated.

Control store 710 typically comprises a readable memory such as a flash RAM, EEPROM, or other types of nonvolatile programmable memory. As illustrated, typically control store 710 comprises a 8 to 16 bit×64K memory array, preferably a flash RAM by Atmel. Control store 710 is coupled to DSP 800 and servo timing controller 810, and typically serves to store programs and other instructions for DSP 800 and servo timing controller 810. Preferably, control store 710 stores access information that enables retrial of the above information from the media and calibration data.

Read data processor 720 typically comprises a Partial Read/Maximum Likelihood (PRML) encoder/decoder. PRML read channel technology is well known, and read data processor 720 is typically embodied as a 81M3010 chip from MARVELL company. Other read data processors, for example from Lucent Technologies are contemplated in alternative embodiments of the present invention. As illustrated, read data processor 720 is coupled to error detection and correction module 790 to provide ECC and data transport functionality.

Interface module 780 typically provides an interface to controller 220, for example. Interfaces include a small computer standard interface (SCSI), an IDE interface, parallel interface, PCI interface or any other known or custom interface. Interface module 780 is typically embodied as an AK-8381 chip from Adaptec, Inc. Interface module 780 is coupled to error detection and correction module 790 for transferring data to and from the host system.

Error detection and correction module 790 is typically embodied as a AIC-8381B chip from Adaptec, Incorporated. This module is coupled by a read/write data line to read data processor 720 for receiving read data and for ECC. This module is also coupled to read data processor 720 by a now return to zero (NRZ) data and control now return to zero line. Other vendor sources of such functionality are contemplated in alternative embodiments of the present invention.

DSP 800 typically provides high-level control of the other modules in FIG. 6. DSP 800 is typically embodied as a AIC-4421A DSP from Adaptec, Inc. As shown, DSP 800 is coupled to read data processor 720 to provide control signals for decoding signals read from a magnetic disk. Further, DSP 800 is coupled to servo timing controller 810 for controlling VCM 750 and spindle motor 760. Other digital signal processors can be used in alternative embodiments, such as DSPs from TI or Motorola.

Servo timing controller 810 is typically coupled by a serial peripheral port to read data processor 720 and to motor drivers 740. Servo timing controller 810 typically controls motor drivers 740 according to servo timing data read from the removable media. Servo timing controller 810 is typically embodied in a portion of DSP800.

Motor driver 740 is typically embodied as a L6260L Chip from SGS-Thomson. Motor driver 740 provides signals to voice coil motor 750 and to spindle motor 760 in order to control the reading and writing of data to the removable media.

Spindle motor 760 is typically embodied as an 8 pole Motor from Sankyo Company. Spindle motor 760 typically is coupled to a center hub of the removable media as illustrated in FIG. 4 and rotates the removable media typically at rates from 4500 to 7200 revolutions per minute. Other manufacturers of spindle motor 760 and other rates of revolution are included in alternative embodiments.

VCM 750 is a conventionally formed voice coil motor. Typically VCM 750 includes a pair of parallel permanent magnets, providing a constant magnetic flux. VCM 750 also includes an actuator having a voice coil, and read/write heads. Read/write heads are typically positioned near the end of the actuator arm, as illustrated in FIG. 5A. The voice coil is typically electrically coupled to motor driver 740. VCM 750 is positioned relative to the magnetic disk in response to the amount of magnetic flux flowing through the voice coil. FIG. 5F illustrates a typical first position 667 of VCM 668 and a typical second position 669 in response to different magnetic fluxes from motor driver 740. As a result, read/write heads 632 are repositioned relative to disk 666 as shown.

In a preferred embodiment of the present invention read/write heads are separate heads that utilize magneto resistive technology. In particular, the MR read/write heads. Typically a preamplifier circuit is coupled to the read/write heads.

In the preferred embodiment of the present embodiment the removable media cartridge is comprises as a removable magnetic disk. When reading or writing data upon the magnetic disk the read/write heads on the end of the actuator arm “fly” above the surface of the magnetic disk. Specifically, because the magnetic disk rotates at a high rate of speed, typically 5400 rpm, a negative pressure pulls the read/write heads towards the magnetic disk, until the read/write heads are typically 0.001 millimeters above the magnetic disk.

For power-off purposes, in one embodiment, the magnetic disk is allowed to slow to approximately 2000 rpm before unloading the read/write heads. At such speeds, the negative pressure on the read/write heads drops to approximately half the force as at 5400 rpm, thus facilitating the unloading of heads off the magnetic disk and onto a load/unload ramp. In other embodiments, upon power-off request (e.g. power-on reset), the magnetic disk is accelerated from a typical 5400 rpm to approximately 7000 rpm before unloading the read/write heads. At such higher speeds, the read/write heads fly above the magnetic disk at more consistent heights, therefore unloading is more consistent.

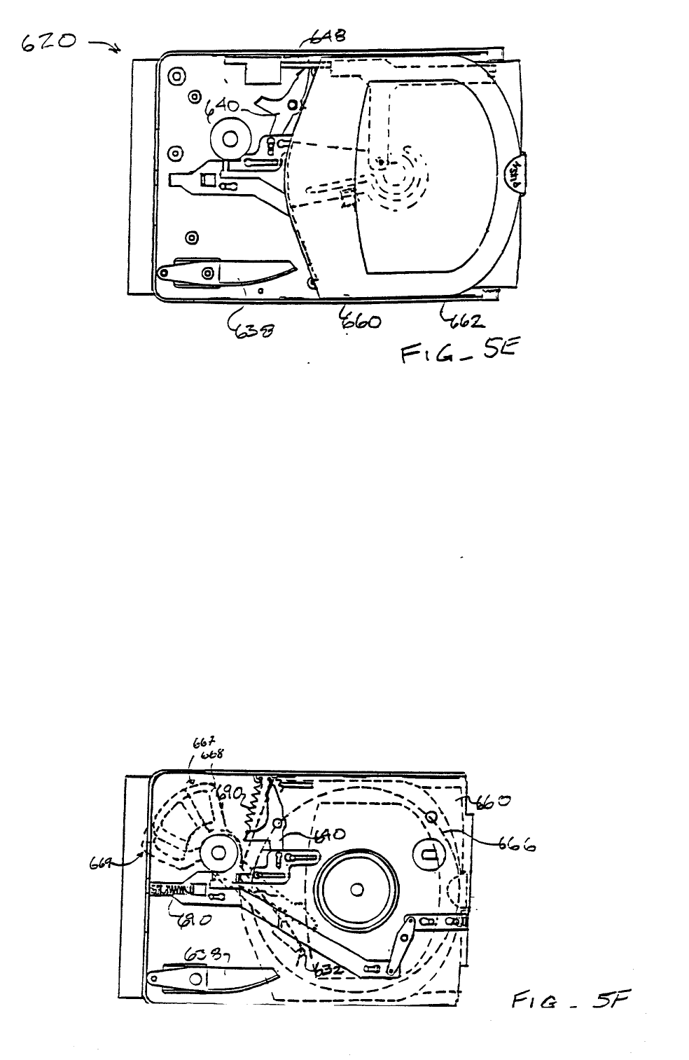

FIG. 7 illustrates a functional block diagram of a circuit for unloading read/write heads from the magnetic disk and onto a loading/unloading ramp. FIG. 7 includes a more detailed block diagram of motor driver 740, above, including a dynamic braking/driver block 850, a retracting block 860, a power-off solenoid driver circuit 870, and a switching circuit 880, each responsive to a power-on-reset (POR) signal.

The solenoid 890 represents the voice coil described in conjunction with VCM 750, above and includes terminals 900 and 910. Although not shown, solenoid 890 is also coupled to a power-on solenoid driver circuit by the same or different terminals for conventional power-on operation of solenoid 890 and the actuator arm.

In FIG. 7, when the power-on-reset (POR) signal is asserted by a reset generator, the spindle motor is typically decoupled from a spindle driving voltage. The POR signal may be asserted (active low in the present embodiment) in response to the user turning-off the unit, the user asserting a reset button on the unit, the user re-booting an attached computer system, power glitches, loose power connections, and in other types of situations.

In response to the POR signal, a back EMF voltage (VBEMF) is generated and is applied to voltage line 920. As previously noted, VBEMF is typically derived from energy produced by a motor when the drive voltage is removed. VBEMF is typically ranges from about 2 to about 3 volts if the supply voltage is about 5 volts, and about 5 to about 6 volts if the supply voltage is about 12 volts, and can typically provide 40 to 60 ma of current; these values can vary significantly in specific embodiment. The duration of time in which VBEMF is generated typically ranges from 100 milliseconds to 300 milliseconds, although specific durations depend upon actual configurations.

As shown in FIG. 7, voltage line 920 is coupled to solenoid driver 870. In response to the POR signal, solenoid driver 870 provides a drive voltage 875 to switching circuit 880 based upon the voltage on voltage line 920, VBEMF. Switching circuit 880 then provides the drive voltage to park the read/write heads in an inner crash stop region of the magnetic disk or to unload the read/write heads onto the load/unload ramp. Details of solenoid driver 870 are discussed in greater detail below.

Switching circuit 880 provides more reliable unloading of read/write heads onto a load/unload ramp by using a reverse-forward parking technique described in application serial no. ______ filed ______ entitled Reverse-forward Power-off Method And Device For Electronic Storage Apparatus, attorney docket no. 18525-002210, assigned to the same assignee. This application is incorporated by reference for all purposes.

In the present embodiment, switching circuit 880 provides the drive voltage to solenoid 890 in a first polarity to bias the read/write heads towards the inner diameter of the magnetic disk (reverse parking). After a preset amount of time has elapsed, switching circuit provides the drive voltage to solenoid 890 in a second polarity to bias the read/write heads towards the outer diameter of the magnetic disk and onto a load/unload ramp (forward parking). In alternative embodiments, of the present invention, switching circuit 880 may only provide reverse parking or only forward parking.

In embodiments of the present invention, the spindle motor is dynamically braked by dynamic braking/driver block 850 after the read/write heads have been moved to a safe position. In the embodiment in FIG. 7, dynamic braking/driver block 850 and retracting block 860 are embodied within motor driver 740. In one embodiment, motor driver 740 is an L6260L chip from SGS-Thomson. Other motor driver chips from other vendors are also usable in alternative embodiments of the present invention.

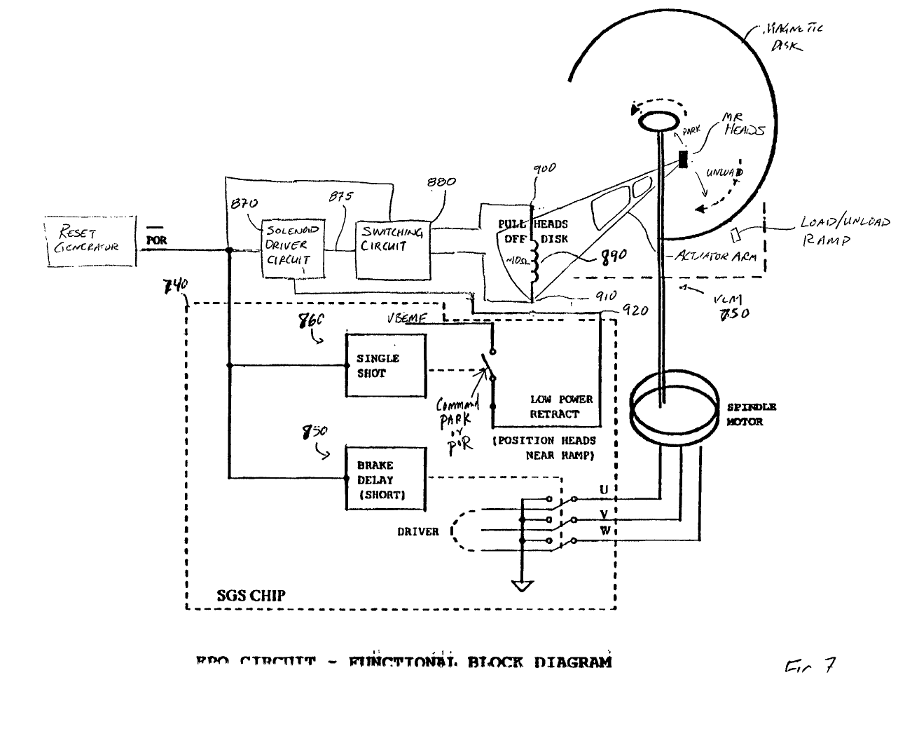

FIG. 9 illustrates a solenoid driving circuit according to an embodiment of the present invention. FIG. 9 includes a current source 1000, a resistor R1 1010, a resistor R2 1020, a resistor R3 1030, an NMOS transistor M1 1040, a PMOS transistor M2 1050, and a switch 1060.

In FIG. 9, the control gate of M1 1040 is coupled to current source 1000 at point 1070 and to ground via R1 1010, when POR is active. One current flowing terminal (source) of M1 1040 is coupled to resistor R2 1020 and to the control gate of M2 1050, and the other current flowing terminal (drain) of M1 1040 is coupled to ground. Voltage line 920 is coupled to the other terminal of resistor R2 1020 and to a current flowing terminal (source) of M2 1050. The other current flowing terminal (drain) 1080 of M2 1050 is coupled to a terminal of resistor R3 1030. The other terminal of resistor R3 1030 provides the drive voltage 875.

The resistance of solenoid 890 (Rcoil) is on the order of approximately 10 ohms. In the present embodiment, resistor R1 1010 has a resistance of approximately 100 Kohms, resistor R2 1020 has a resistance of approximately 100 Kohms, and resistor R3 1030 has a resistance of approximately 10 ohms.

In operation, when a POR signal is asserted, switch 1060 couples current source 1000 to ground via resistor R1 1010. As a result, the voltage at point 1070 rises to V=I*R1. The resistance of resistor R1 1010 is selected such that the voltage at point 1070 is sufficient to facilitate saturation of M1 1040. The resistance of resistor R1 1010 can thus vary substantially in alternative embodiments of the present invention.

When M1 1040 is substantially saturated, the control gate of M2 1050 is effectively grounded, thus the voltage at current flowing terminal 1080 becomes effectively equal to VBEMF. When solenoid driver circuit 870 is coupled to solenoid 890 via switching circuit 880, VBEMF=Icoil(R3+Rcoil), where Icoil is the amount of current flowing through the coil. Icoil thus equals to Icoil=VBEMF/(R3+Rcoil). In the present embodiment, the resistance of resistor R3 is selected to be small, approximately 10 ohms, thus allowing current Icoil to be larger. The current handling capacity of M2 1050 must be able to supply Icoil. The resistance of resistor R3 1030 can thus vary substantially in alternative embodiments of the present invention.

It should be understood that any conventional MOS transistors can be used for M1 1040 and M2 1050 in embodiments of the present invention. For example, M1 1040 and M2 1050 may be formed on an integrated circuit. In other embodiments, switching circuit 880 may provide reverse-forward parking, as described below, or simply provide the drive voltage to solenoid 890.

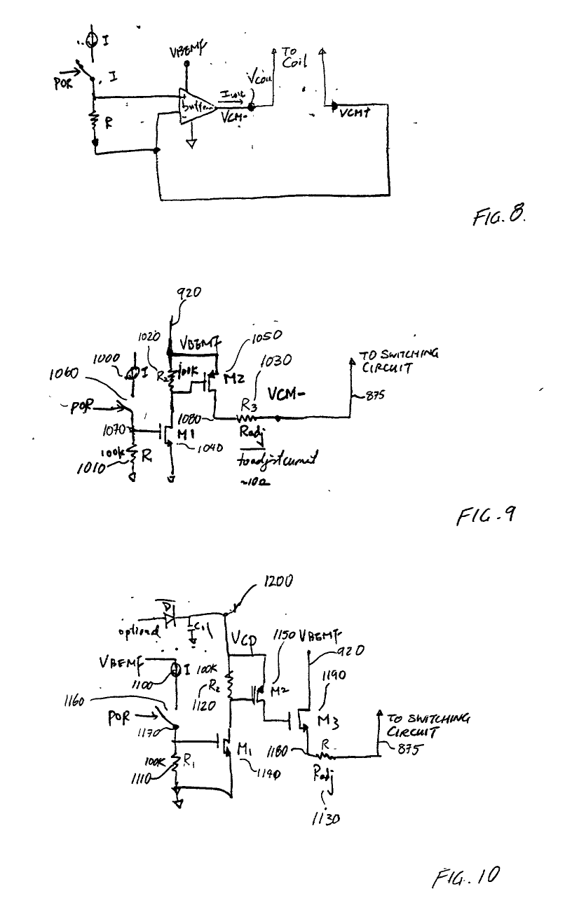

FIG. 10 illustrates another solenoid driving circuit according to an embodiment of the present invention. FIG. 10 includes a current source 1100, a resistor R1 1110, a resistor R2 1120, a resistor R3 1130, an NMOS transistor M1 1140, a PMOS transistor M2 1150, an NMOS transistor M3 1190, and a switch 1160.

In FIG. 10, the control gate of M1 1140 is coupled to current source 1100 at point 1170 and to ground via R1 1110, when POR is active. One current flowing terminal (source) of M1 1140 is coupled to resistor R2 1120 and to the control gate of M2 1150, and the other current flowing terminal (drain) of M1 1140 is coupled to ground. A voltage line 1200 is coupled to the other terminal of resistor R2 1120 and to a current flowing terminal (source) of M2 1150. Voltage line 1200 provides a charge-pump voltage, Vcp, preferably when POR is active.

The other current flowing terminal (drain) of M2 1150 is coupled to the control gate of M3 1190. One current flowing terminal (source) of M3 1190 is coupled to voltage line 920, and the other current flowing terminal (drain) 1180 is coupled to a terminal of resistor R3 1130. The other terminal of resistor R3 1130 provides the drive voltage 875 to switching circuit 880.

In the present embodiment, resistor R1 1110 has a resistance of approximately 100 Kohms, resistor R2 1120 has a resistance of approximately 100 Kohms, resistor R3 1130 has a resistance of approximately 10 ohms, and solenoid 890 typically has a characteristic resistance (Rcoil) on the order of approximately 10 ohms.

In operation, when a POR signal is asserted, switch 1160 couples current source 1100 to ground via resistor R1 1110. As a result, the voltage at point 1170 rises to VBEMF. The resistance of resistor R1 1110 is selected such that the voltage at point 1170 is sufficient to facilitate saturation of M1 1140. The resistance of resistor R1 1110 can thus vary substantially in alternative embodiments of the present invention.

When M1 1140 is substantially saturated, the control gate of M2 1150 is effectively grounded, thus the voltage at the other current flowing terminal of M2 1150 becomes effectively equal to Vcp. When control gate of M3 1190 is substantially saturated. Vcp is selected such that M3 1190 is sufficiently saturated, thus the voltage of Vcp can thus vary substantially in alternative embodiments of the present invention.

When M3 1190 is substantially saturated, the voltage applied at current flowing terminal 1180 becomes effectively equal to VBEMF. When solenoid driver circuit 870 is coupled to solenoid 890 via switching circuit 880, VBEMF=Icoil(R3+Rcoil), where Icoil is the amount of current flowing through the coil. Icoil thus equals to Icoil=VBEMF/(R3+Rcoil).

In the present embodiment, the resistance of resistor R3 is selected to be small, approximately 10 ohms, thus allowing current Icoil to be larger. The resistance of resistor R3 1130 can thus vary substantially in alternative embodiments of the present invention.

In this embodiment, the current handling ability of M2 1150 is typically smaller than the current handling ability of M2 1050, thus M2 1150 is physically smaller than M2 1050. In the present embodiment, PMOS transistors are typically more expensive to fabricate than NMOS transistors, thus the embodiment in FIG. 10 may be less expensive because of the smaller size of PMOS transistor M2 1150.

It should be understood that any conventional MOS transistors can be used for M1 1140, M2 1150, and M3 1190 in embodiments of the present invention. For example, M1 1140, M2 1150, and/or M3 1190 may be formed on an integrated circuit. In other embodiments, switching circuit 880 may provide reverse-forward parking, as described below, or simply provide the drive voltage to solenoid 890.

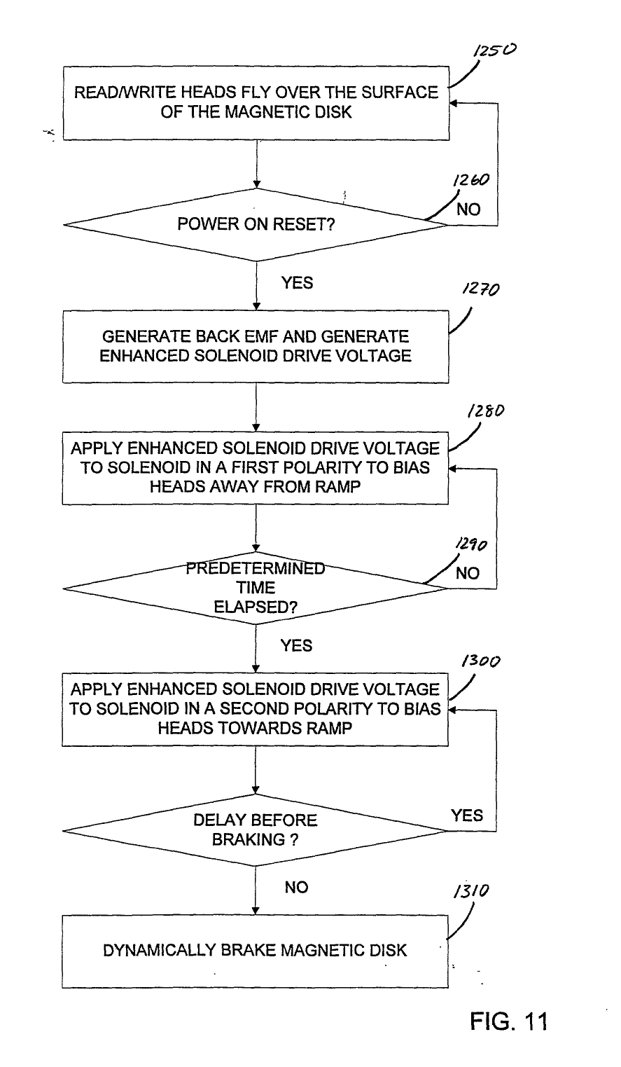

FIG. 11 illustrates a block diagram of a method for unloading heads according to an embodiment of the present invention. Such this method includes a head unloading technique termed “reverse-forward” parking.

Initially, the read/write heads (magneto resistive) heads fly above the magnetic disk, step 1250. Upon detection of a power on reset signal (POR), step 1260, an enhanced drive voltage is produced by solenoid driver circuit 870, step 1270. Using the enhanced drive voltage, switching circuit 880 couples the drive voltage to solenoid 890 in a first polarity, therefore biasing the MR heads towards the inner diameter of the magnetic disk, step 1280. Preferably, the MR heads reach the inner diameter of the magnetic disk, typically a crash stop. This first step is termed herein reverse parking.

After a predetermined amount of time has elapsed, step 1290, using the enhanced drive voltage, switching circuit 880 couples the drive voltage to solenoid 890 in a second polarity, therefore biasing the MR heads towards the outer diameter of the magnetic disk, step 1300. Preferably, the MR heads reach the outer diameter of the magnetic disk, and unload onto a load/unload ramp. This second step is termed forward parking.

After an additional delay, the magnetic disk may be dynamically braked, step 1310.

The predetermined amount of time is typically determined in response to an estimated worse case amount of time it would take the MR heads to travel from the outer diameter of the magnetic disk to the inner diameter of the magnetic disk in response to a back EMF. By doing so enhances the probability that despite where the MR heads are located on the magnetic disk, after the predetermined amount of time has elapsed after the POR signal, the MR heads will most likely be at the inner diameter of the magnetic disk.

After this predetermined amount of time, the MR heads are sent back to the outer diameter in response to the back EMF, and preferably onto the load/unload ramp. Because the MR heads will most likely be at the inner diameter of the magnetic disk before being sent towards the outer diameter, there is a greater consistency in total amount of work energy applied to the MR heads, greater consistency as to position of the MR heads up the load/unload ramp, and the like.

In alternative embodiments, the MR heads may be initially biased towards the outer diameter of the magnetic disk for a period of time, and then biased towards the inner diameter of the magnetic disk after the period of time. Such embodiments would also facilitate greater consistency as to MR head positioning during power-off.

The embodiments of the solenoid driving circuits 870, as illustrated by way of example in FIGS. 9 and 10, provide enhanced drive voltage to solenoid 890 via switching circuit 880. The enhanced drive voltage therefore facilitates more reliable read/write head unloading onto load/unload ramps.

Conclusion

In the foregoing specification, the invention has been described with reference to specific exemplary embodiments thereof. Many changes or modifications are readily envisioned in alternative embodiments of the present invention, for example switching circuit 880 may provide only forward or reverse parking.

In other contemplated embodiments, before reverse-forward parking is performed with the embodiments of the present invention, the position of the read/write head on top of the magnetic disk is first determined. If the position of the heads is within a predetermined position from the inner diameter of the magnetic disk, reverse parking is not performed, and the heads are forward parked. Such embodiment would provide quicker power-off parking of the heads in certain situations.

In another embodiment, reverse parking occurs for a sufficient amount of time for the heads to be positioned at least a pre-determined distance away from the outer diameter of the magnetic disk, as opposed to the inner diameter. Forward parking would follow as disclosed in the above embodiments. Such embodiments would provide quicker power-off parking of the heads, since the reverse parking time is reduced.

Many different embodiments for circuit designs are envisioned that measure the amount of time for reverse parking. For example, counter circuits, up/down counters, analog RC circuits, as well as other circuits, are contemplated in embodiments of the present invention.

The presently claimed inventions may also be applied to other areas of technology such as mass storage systems for storage of video data, audio data, textual data, program data, or any computer readable data in any reproducible format.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. An apparatus for retracting magneto resistive heads from a position adjacent to a surface of a magnetic disk, the magneto resistive head positioned upon an actuator arm also having a voice coil, the apparatus including:
a reset generator for asserting a reset signal;
a spindle motor coupled to the magnetic disk and to the reset generator for rotating the magnetic disk, and for generating an EMF voltage in response to the reset signal; and
a voice coil driver coupled to the reset generator, to the spindle motor, and to the voice coil, the voice coil driver for generating a drive voltage for the voice coil in response to the EMF voltage, the voice coil driver comprising:
a charge pump for providing a charge pump voltage;
a first resistor having a first terminal coupled in series to the switching circuit for providing the drive voltage;
a second resistor having a first terminal coupled to receive the charge pump voltage;
a first NMOS transistor having a source, a drain, and a gate, the source coupled to a second terminal of the first resistor, the drain coupled to receive the EMF voltage, the first NMOS transistor for providing the EMF voltage to the first resistor when saturated;
a PMOS transistor having a source, a drain, and a gate, the source coupled to receive the charge pump voltage, the gate coupled to a second terminal of the second resistor, and the source coupled to the gate of the first NMOS transistor for providing the charge pump voltage to the gate of the first NMOS transistor and for causing the first NMOS transistor to saturate when the PMOS transistor is saturated;
a third resistor having a first terminal that is grounded;
a second NMOS transistor having a source, a drain, and a gate, the drain coupled to ground, the source coupled to the second terminal of the third resistor, and the source coupled to the gate of the PMOS transistor for causing the PMOS transistor to saturate when the second NMOS transistor is saturated; and
a switch coupled to the EMF voltage and to the gate of the second NMOS transistor for coupling the EMF voltage to the gate of the second NMOS transistor and for causing the second NMOS transistor to saturate in response to the reset signal.

2. The apparatus of claim 1 further comprising a switching circuit coupled between the voice coil driver and the voice coil, the switching circuit for providing the drive voltage to the voice coil at a first polarity for a pre-determined amount of time.

3. The apparatus of claim 2 wherein the switching circuit is also for providing the drive voltage to the voice coil at a second polarity after the pre-determined amount of time.

4. The apparatus of claim 1 wherein the spindle motor is also for increasing a rotation speed of the magnetic disk in response to the reset signal prior to generating the EMF voltage.

5. An apparatus for repositioning a magneto resistive head disposed upon an actuator arm from a position adjacent to a surface of a magnetic disk onto a head load/unload ramp, the actuator arm including a voice coil motor, the apparatus comprising:
a reset generator for asserting a reset signal;
a spindle motor coupled to the magnetic disk for rotating the magnetic disk a number or revolutions per second, and for generating a back electro-motive force in response to the reset signal, and for providing a voltage in response to the back electro-motive force; and
a voice coil motor driver coupled to the voice coil motor, to the spindle motor, and to the reset generator for driving the voice coil motor, the voice coil motor driver comprising:
a first resistor having a first terminal and a second terminal;
a second resistor having a first terminal and a second terminal, the first terminal coupled to receive the voltage;
a PMOS transistor having a source, a drain, and a gate, the source coupled to the first terminal of the first resistor, the drain coupled to receive the voltage, and the gate coupled to the second terminal of the second resistor, the PMOS transistor for providing the voltage to the first resistor when saturated;
a switching circuit coupled to the second terminal of the first resistor for providing a drive voltage to a second terminal of the voice coil motor in response to the reset signal and for coupling a first terminal of the voice coil motor to ground in response to the reset signal;
a third resistor having a first terminal grounded;
an NMOS transistor having a source, a drain, and a gate, the drain coupled to ground, the source coupled to the second terminal of the third resistor, and the source coupled to the gate of the PMOS transistor for causing the PMOS transistor to saturate when the NMOS transistor is saturated; and
a switch coupled to the gate of the NMOS transistor for causing the NMOS transistor to saturate in response to the reset signal.

6. The apparatus of claim 5
wherein the switching circuit provides the drive voltage to a second terminal of the voice coil motor and couples ground to the first terminal of the voice coil motor for a first period of time, and
wherein the switching circuit provides the drive voltage to the first terminal of the voice coil motor and couples ground to the second terminal of the voice coil motor for a second period of time after the first period of time.

7. The apparatus of claim 6 wherein the switching circuit comprises a counter.

8. The apparatus of claim 6 wherein the first period of time is approximately 1.5 milliseconds

9. A system including a storage unit having an actuator arm including a magneto resistive head and a voice coil disposed thereon, for repositioning the magneto resistive head from a position adjacent to a surface of a magnetic disk onto a head load/unload ramp, the storage unit comprising:
a reset generator for asserting a reset signal;
a spindle motor coupled to the magnetic disk and to the reset generator for rotating the magnetic disk, and for generating an EMF voltage in response to the reset signal;
a switching circuit coupled to a first terminal of the voice coil, to a second terminal of the voice coil, and to the reset generator, the switching circuit for providing a drive voltage to the first terminal of the voice coil and for coupling ground to the second terminal of the voice coil, in response to the reset signal; and
a voice coil driver coupled to the reset generator, the spindle motor, and to the switching circuit, the voice coil driver for generating the drive voltage in response to the EMF voltage, the voice coil driver comprising:
a charge pump for providing a charge pump voltage;
a first resistor having a first terminal coupled in series to the switching circuit for providing the drive voltage;
a second resistor having a first terminal coupled to receive the charge pump voltage;
a first NMOS transistor having a source, a drain, and a gate, the source coupled to a second terminal of the first resistor, the drain coupled to receive the EMF voltage, the first NMOS transistor for providing the EMF voltage to the first resistor when saturated;
a PMOS transistor having a source, a drain, and a gate, the source coupled to receive the charge pump voltage, the gate coupled to a second terminal of the second resistor, and the source coupled to the gate of the first NMOS transistor for providing the charge pump voltage to the gate of the first NMOS transistor and for causing the first NMOS transistor to saturate when the PMOS transistor is saturated;
a third resistor having a first terminal that is grounded;
a second NMOS transistor having a source, a drain, and a gate, the drain coupled to ground, the source coupled to the second terminal of the third resistor, and the source coupled to the gate of the PMOS transistor for causing the PMOS transistor to saturate when the second NMOS transistor is saturated; and
a switch coupled to the EMF voltage and to the gate of the second NMOS transistor for coupling the EMF voltage to the gate of the second NMOS transistor and for causing the second NMOS transistor to saturate in response to the reset signal.

10. The storage unit of claim 9 wherein the switching circuit provides the drive voltage to the first terminal of the voice coil and couples ground to the second terminal of the voice coil for a predetermined amount of time.

11. The storage unit of claim 9 wherein the switching circuit is also for providing the drive voltage to the second terminal of the voice coil and for coupling ground to the first terminal of the voice coil after the predetermined amount of time.

12. The storage unit of claim 10 wherein the predetermined amount of time is less than approximately 1.5 milliseconds.

13. The storage unit of claim 9 wherein the spindle motor is also for increasing a rotation speed of the spindle motor in response to the reset signal prior to generating the EMF voltage.
